(19) United States
(12) Patent Application Publication
(10) Pub. No.: US 2007/0273777 A1
(43) Pub. Date: Nov. 29, 2007

(54) Solid-state imaging device

(75) Inventor: Tetsu Wada, Miyagi (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/712,523

(22) Filed: Mar. 1, 2007

(30) Foreign Application Priority Data
Mar. 6, 2006 (JP) P2006-059942

(51) Int. Cl. H04N 5/335

(52) U.S. Cl. 348/294; 348/E05.091

(57) ABSTRACT

A solid-state imaging device comprises: photoelectric conversion elements including color-detecting photoelectric conversion elements and luminance-detecting photoelectric conversion elements; color filters each provided above each of the color-detecting photoelectric conversion elements; and luminance filters each provided above each of the luminance-detecting photoelectric conversion elements. Each of the luminance-detecting photoelectric conversion elements is provided adjacent to each of the color-detecting photoelectric conversion elements. Provided that incident ranges of light portions assumed to respectively enter the color-detecting photoelectric conversion elements are taken as a first set of incident ranges, and incident ranges of light portions assumed to respectively enter the luminance-detecting photoelectric conversion elements are taken as a second set of incident ranges, on a same plane lying above the photoelectric conversion elements, the color filters, when viewed in plan, are provided broadening into the second set of incident ranges.

### BACKGROUND OF THE INVENTION

1. Field of the Invention

The present invention relates to a solid-state imaging device having a multiplicity of photoelectric conversion elements including color-detecting photoelectric conversion elements in at least three types for respectively detecting different color components of light and luminance-detecting photoelectric conversion elements each provided adjacent to any of the at least three types of photoelectric conversion elements and for detecting an luminance component of light.

2. Description of the Related Art

In the related art, there is proposed a solid-state imaging device having a multiplicity of photoelectric conversion elements including luminance-detecting photoelectric conversion elements that detect a luminance component of light and color-detecting photoelectric conversion elements that detect R (red), G (green) and B (blue) components of light (JP-A-2003-318375).

FIG. 3 is a typical plan view of the related-art solid-state imaging device. In the solid-state imaging device shown in FIG. 3, a multiplicity of photoelectric conversion elements are arranged vertically and horizontally in a two dimensional regular form. In FIG. 3, there is shown a plan view of a solid-state imaging device including sixteen photoelectric conversion elements in total, i.e. four vertically 4× four horizontally.

The square block shown in FIG. 3 represents an incident range assumed for light to enter the photoelectric conversion element included in the relevant block. The reference character, described in the block, represents the component of light to be detected by the photoelectric conversion element included in the relevant block. The incident range can be desirably established upon designing of the solid-state imaging device. The reference character “Y” represents a luminance component of light, “R” a red component of light, “G” a green component of light, and “B” a blue component of light. From now on, the incident range described with reference character “Y” is referred to as an incident range Y, the incident range described with reference character “R” is as an incident range R, the incident range described with reference character “G” is as an incident range G, and the incident range described with reference character “B” is as an incident range B.

FIG. 4 is a typical sectional view of the FIG. 3 solid-state imaging device taken on line A-A.

As shown in FIG. 4, photoelectric conversion elements 22 same in characteristic are arranged one in each of the incident ranges R, G, B, Y, in a silicon substrate 21. An r-color filter 24, transmissive of an R component of light, is provided above a light-receiving surface of the photoelectric conversion element included in the incident range R. A g-color filter, transmissive of a G component of light, is provided above a light-receiving surface of the photoelectric conversion element included in the incident range G. A b-color filter, transmissive of a B component of light, is provided above a light-receiving surface of the photoelectric conversion element included in the incident range B. A luminance filter 23, having a spectral characteristic correlated to the luminance component of light, is provided above a light-receiving surface of the photoelectric conversion element included in the incident range Y. From now on, the photoelectric conversion element included in the incident range R is referred also to as an R photoelectric conversion element, the photoelectric conversion element included in the incident range G is as a G photoelectric conversion element, the photoelectric conversion element included in the incident range B is as a B photoelectric conversion element, and the photoelectric conversion element included in the incident range Y is as a Y photoelectric conversion element.

In the solid-state imaging device shown in FIGS. 3 and 4, any of an luminance filter (y-filter) 23, an r-color filter 24, a g-color filter and a b-color filter is provided above each light-receiving surface of the multiplicity of photoelectric conversion elements that are arranged vertically and horizontally and identical in characteristic. The luminance filters 23 are provided above the light-receiving surfaces of the photoelectric conversion elements in a checkered arrangement of among the photoelectric conversion elements arranged vertically and horizontally. The r, g and b color filters are provided above the light-receiving surfaces of the remaining photoelectric conversion elements arranged in the checkered form.

Namely, in the solid-state imaging device shown in FIGS. 3 and 4, for the even rows, filters are arranged as “y, g, y, g, . . . ” over the receiving surfaces of the respective photoelectric conversion elements. For the odd rows, alternate arrangement are provided with the row where arranged as “r, y, b, y, r, . . . ” and the row where arranged as “b, y, r, y, b, . . . ”, over the receiving surfaces of the respective photoelectric conversion elements.

The luminance filters 23 are applicable with ND filters, transparent filters, white filters, gray filters or the like. However, such an arrangement can be considered as a provision of luminance filters that allows light to directly enter the light-receiving surfaces without the provision of anything above the light-receiving surfaces of the photoelectric conversion elements.

Meanwhile, micro-lenses 25 are each provided above the color filter lying in any of the incident range R, G or B or above the luminance filter lying in the incident range Y, in order to focus the light entering in the incident range on the photoelectric conversion element 2 provided in the incident range. The incident range R, G, B, Y has a size in plan equal to the size in plan of the micro-lens 25 included therein. Namely, the incident range is determined depending upon the size of the micro-lens 25.

Such a solid-state imaging device can obtain a luminance resolution not relying upon color information and a color reproduction not relying upon the spectral characteristic of a luminance component because of the capability of separately detecting a luminance component of and a color component of light.

The usual solid-state imaging device with color filters is designed with its color filters without giving gaps, as shown in FIG. 4. For this reason, where the color filters are aligned poor or manufacturing errors are encountered, the following problem possibly arises.

For example, in the solid-state imaging device structured as above, assumption is made that the micro-lens 25 lying in the incident range R, G, B is provided with a focus characteristic different from the focus characteristic of the micro-lens 25 lying in the incident range Y (e.g. not providing a micro-lens 25 in the incident range R, G, B) for the purpose of improving the sensitivity of the R, G and B photoelectric conversion elements. In this case, where the r-color filter 24 is smaller than the design as shown in FIG. 5 or the r-color filter 24 is arranged deviated greater toward the luminance filter 23 than the design as shown in FIG. 6, part of the light entering the incident range R is to directly enter the R-photoelectric conversion element lying below the r-color filter 24 without the passage through the r-color filter 24.

The R-photoelectric conversion element 22 is provided on the premise to receive the light whose spectral characteristic is under control of the r-color filter 24. In the event the light whose spectral characteristic is not under control is incident upon the R-photoelectric conversion element 22, the R-photoelectric conversion element 22 provides a signal that is deteriorated in color reproduction. Naturally, even where the micro-lens 25 is provided in the incident range R, G, B, such a problem occurs in the presence of significant manufacturing errors.

### SUMMARY OF THE INVENTION

The present invention, made in view of the foregoing circumstance, aims at providing a solid-state imaging device that color reproducibility is prevented from lowering due to the manufacturing errors.

A solid-state imaging device in the present invention is a solid-state imaging device comprising: a plurality of photoelectric conversion elements including (i) color-detecting photoelectric conversion elements that detect different color components of light and (ii) luminance-detecting photoelectric conversion elements that detects a luminance component of light, each of the luminance-detecting photoelectric conversion elements is provided adjacent to each of the color-detecting photoelectric conversion elements; color filters each of which is provided in a position above each of the color-detecting photoelectric conversion elements, the color filters comprising at least three type of color filters that transmit different color components of light; and luminance filters each of which is provided in a position above each of the luminance-detecting photoelectric conversion elements, the luminance filters having a spectral characteristic correlated to a luminance component of light; wherein, provided that incident ranges of light portions assumed to respectively enter the color-detecting photoelectric conversion elements are taken as a first set of incident ranges, and incident ranges of light portions assumed to respectively enter the luminance-detecting photoelectric conversion elements are taken as a second set of incident ranges, on a same plane lying above said plurality of photoelectric conversion elements, the color filters, when viewed in plan, are provided broadening into the second set of incident ranges, each incident range of the second set of incident ranges being adjacent to each incident range of the first set of incident ranges.

The solid-state imaging device in the invention may further comprises micro-lenses provided respectively above the luminance-detecting photoelectric conversion elements, wherein the first set of incident ranges and the second set of incident ranges are defined by peripheral edges of the micro-lenses.

### BRIEF DESCRIPTION OF THE DRAWINGS

FIG. 1 is a typical plan view of a solid-state imaging device for explaining an embodiment of the present invention;

FIG. 2 is a typical sectional view of the FIG. 1 solid-state imaging device taken on line A-A;

FIG. 3 is a typical plan view of the related-art solid-state imaging device;

FIG. 4 is a typical sectional view of the FIG. 3 solid-state imaging device taken on line A-A;

FIG. 5 is a typical sectional view on line A-A of the FIG. 3 solid-state imaging device where no micro-lenses are provided in the incident ranges R, G, B; and

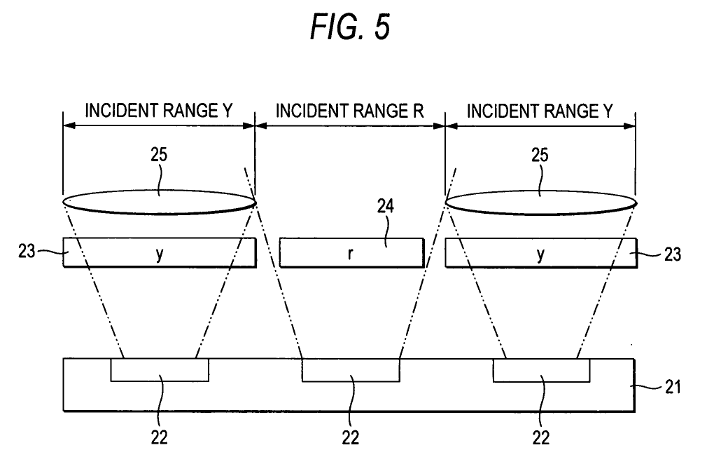

FIG. 6 is a typical sectional view on line A-A of the FIG. 3 solid-state imaging device where no micro-lenses are provided in the incident ranges R, G, B.

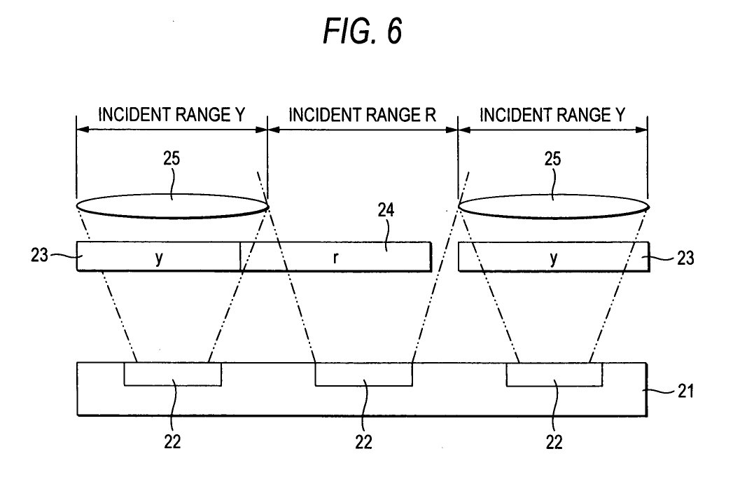

### DETAILED DESCRIPTION OF THE INVENTION

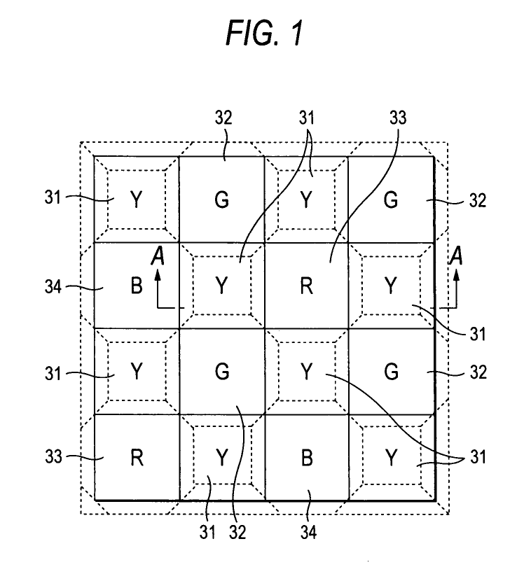

FIG. 1 is a typical plan view of a solid-state imaging device for explaining an embodiment of the present invention.

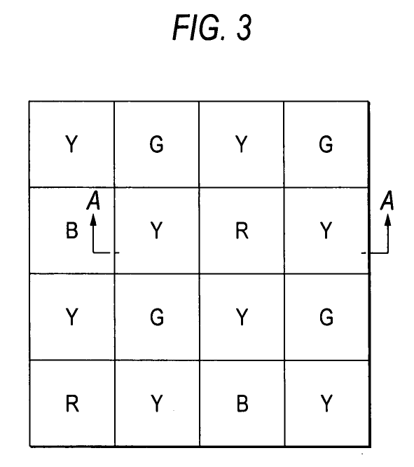

The solid-state imaging device shown in FIG. 1 is different from the solid-state imaging device shown in FIG. 3 only in that the color and luminance filters lying in the respective incident ranges are changed in their forms. In FIG. 1, the elements shown with the broken lines represent color and luminance filters.

In FIG. 1, a luminance filter 31 is formed in an incident range Y, an r-color filter 33 is formed in an incident range R, a g-color filter 32 is formed in an incident range G and a b-color filter 34 is formed in an incident range B. Of the figures shown with the broken lines, those shown at squares are luminance filters 31 while those shown at octagons are color filters 32, 33, 34.

The solid-state imaging device is featured in that, in plan, the r-color filter 33 is formed in a manner broadening into the both-side incident ranges Y adjacent to the incident range (incident range R) through which light is assumed to enter the photoelectric conversion element 22 lying below the relevant r-color filter 33, the g-color filter 32 is formed in a manner broadening into the both-side incident ranges Y adjacent to the incident range (incident range G) through which light is assumed to enter the photoelectric conversion element 22 lying below the relevant g-color filter 32, and the b-color filter 34 is formed in a manner broadening into the both-side incident ranges Y adjacent to the incident range (incident range B) through which light is assumed to enter the photoelectric conversion element 22 lying below the relevant b-color filter 34.

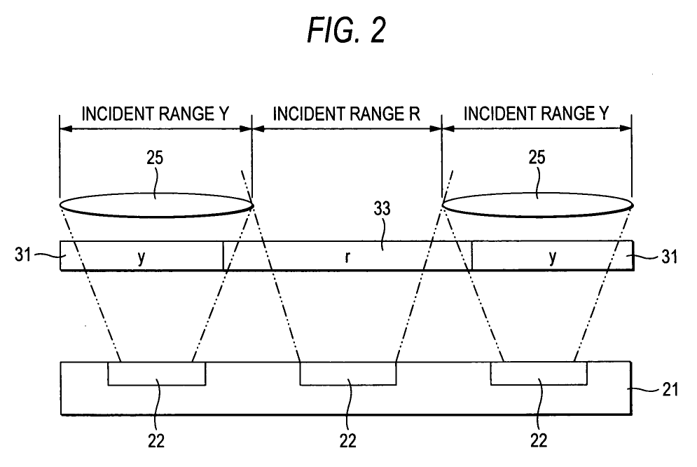

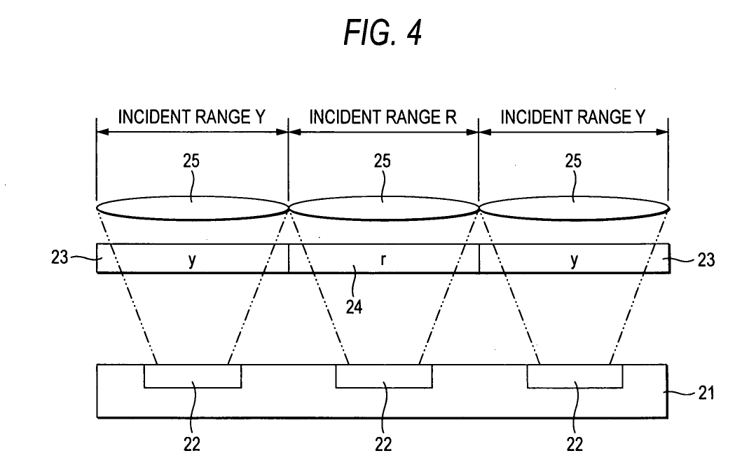

FIG. 2 is a typical sectional view of the FIG. 1 solid-state imaging device taken on line A-A. In FIG. 2, the element same as that in FIG. 4 is attached with the same reference. Although FIG. 2 illustrates an example not provided with micro-lenses in the respective incident ranges R, G, B, micro-lenses may be provided in the respective incident ranges R, G, B.

As shown in FIG. 2, a multiplicity of photoelectric conversion elements 22 are formed in a silicon substrate 21. A luminance filters 31 is formed above a light-receiving surface of a luminance-detecting photoelectric conversion elements 22 that detects a luminance component of light. Above that, a micro-lens 25 is formed. The micro-lens 25 has a size in plan equal to the size of the incident range Y shown in FIG. 1.

An r-color filter 33 is formed above a light-receiving surface of a color-detecting photoelectric conversion elements 22 that detects a red component of light. Above the r-color filter 33, no micro-lens 25 is formed. Because the incident range R is surrounded by the adjacent incident ranges Y as shown in FIG. 1, the incident range R is given as a range defined by the peripheral edges of the micro-lenses 25 provided respectively in the incident ranges Y.

Likewise, a g-color filter 32 is formed above a light-receiving surface of a color-detecting photoelectric conversion elements 22 that detects a green component of light. Above the g-color filter 33, no micro-lens 25 is formed. Because the incident range G is surrounded by the adjacent incident ranges Y as shown in FIG. 1, the incident range G is given as a range defined by the peripheral edges of the micro-lenses 25 provided respectively in the incident ranges Y.

Likewise, a b-color filter 34 is formed above a light-receiving surface of a color-detecting photoelectric conversion elements 22 that detects a blue component of light. Above the b-color filter 34, no micro-lens 25 is formed. Because the incident range B is surrounded by the adjacent incident ranges Y as shown in FIG. 1, the incident range B is given as a range defined by the peripheral edges of the micro-lenses 25 provided respectively in the incident ranges Y.

According to the solid-state imaging device 1b structured above, the r-color filter 32, 33, 34 is formed in a manner broadening into the both-side incident ranges Y adjacent to the incident range through which light is assumed to enter the photoelectric conversion element lying below the same. Accordingly, even where the color filter 32, 33, 43 is arranged deviated in position greater than the design or made smaller in size, it is possible to prevent the occurrence of an area in plan where no color filter exists in the incident range R, G, B. This resultingly can prevent the situation that part of the light entering the incident range R, G, B directly enters the photoelectric conversion element lying below the relevant color filter 32, 33, 34 without the passage through the color filter 32, 33, 34, thus improving the color reproducibility.

Incidentally, in the above structure, part of the light passed the color filter is incident upon the luminance-detecting photoelectric conversion element, as shown in FIG. 2. Nevertheless, the luminance-detecting photoelectric conversion element, because to detect only a luminance component, has less effect upon image quality if other color components of light are incident thereupon, raising no problem if changing the form of the color filter. In this manner, the effect of color reproducibility improvement due to devising the color filter form is an effective technique for a solid-state imaging device having a multiplicity of photoelectric conversion elements including color-detecting photoelectric conversion elements in three types to detect R, G and B color components and luminance-detecting photoelectric conversion elements provided adjacent to the color-detecting photoelectric conversion element.

In the above, explanation was on the assumption the color-detecting photoelectric conversion elements included in the solid-state imaging device include the photoelectric conversion elements that detect three, different color components R, G and B. However, the color components are not limited to those based on the RGB primary colors but may be complimentary-based colors or other colors. Besides, the number of color components is not limited to three but may be four or more.

According to the invention, a solid-state imaging device can be provided that color reproducibility is prevented from lowering due to manufacturing errors.

The entire disclosure of each and every foreign patent application from which the benefit of foreign priority has been claimed in the present application is incorporated herein by reference, as if fully set forth.

What is claimed is:

1. A solid-state imaging device comprising:
a plurality of photoelectric conversion elements including (i) color-detecting photoelectric conversion elements that detect different color components of light and (ii) luminance-detecting photoelectric conversion elements that detects a luminance component of light, each of the luminance-detecting photoelectric conversion elements is provided adjacent to each of the color-detecting photoelectric conversion elements;
color filters each of which is provided in a position above each of the color-detecting photoelectric conversion elements, the color filters comprising at least three type of color filters that transmit different color components of light; and
luminance filters each of which is provided in a position above each of the luminance-detecting photoelectric conversion elements, the luminance filters having a spectral characteristic correlated to a luminance component of light;
wherein, provided that incident ranges of light portions assumed to respectively enter the color-detecting photoelectric conversion elements are taken as a first set of incident ranges, and incident ranges of light portions assumed to respectively enter the luminance-detecting photoelectric conversion elements are taken as a second set of incident ranges, on a same plane lying above said plurality of photoelectric conversion elements, the color filters, when viewed in plan, are provided broadening into the second set of incident ranges, each incident range of the second set of incident ranges being adjacent to each incident range of the first set of incident ranges.

2. The solid-state imaging device according to claim 1, further comprising micro-lenses provided respectively above the luminance-detecting photoelectric conversion elements,
wherein the first set of incident ranges and the second set of incident ranges are defined by peripheral edges of the micro-lenses.

3. The solid-state imaging device according to claim 1,
wherein the color filters comprising a color filter transmissive of a red component of light, a color filter transmissive of a green component of light and a color filter transmissive of a blue component of light.

4. The solid-state imaging device according to claim 1,
wherein the color filters have an octagonal shape and the luminance filters have a square shape.

5. The solid-state imaging device according to claim 4,
wherein the luminance filters are defined by peripheral edges of the color filters.
